(19) United States
(12) Patent Application Publication
(10) Pub. No.: US 2012/0037800 A1
(43) Pub. Date: Feb. 16, 2012

(54) PERFORMANCE EVALUATION METHOD WITH X-RAY AND ITS USAGE

(75) Inventors: Nobuyuki TADOKORO, Shinjuku-ku (JP); Sureerat KUNCHOO, Thanyaburi (TH); Supaporn PANNAKARN, Thanyaburi (TH); Veraphat PARNICH, Thanyaburi (TH)

(73) Assignees: HOYA LENS THAILAND LTD., Patumthani (TH); HOYA CORPORATION, Tokyo (JP)

(21) Appl. No.: 13/096,203

(22) Filed: Apr. 28, 2011

(30) Foreign Application Priority Data
Apr. 28, 2010 (JP) 2010-103739
May 24, 2010 (JP) 2010-117948

(51) Int. Cl. H01J 49/44; H01J 49/08

(52) U.S. Cl. 250/305

(57) ABSTRACT

An aspect of the present invention relates to a method of evaluating performance of a film-forming material for forming a functional film on an eyeglass lens substrate or a functional film formed by the use of the film-forming material. The performance to be evaluated is selected from the group consisting of a sliding sensation of a surface of the functional film and an adhesion of the functional film, and the evaluation is conducted based on a change over time in a quantity of photoelectrons generated by irradiating with an X-ray the film-forming material or the functional film.

### CROSS-REFERENCE TO RELATED APPLICATIONS

This application claims the benefit of priority under 35 USC 119 to Japanese Patent Application No. 2010-103739 filed on Apr. 28, 2010 and Japanese Patent Application No. 2010-117948 filed on May 24, 2010, which are expressly incorporated herein by reference in their entirety.

### FIELD OF THE INVENTION

The present invention relates to a method of evaluating performance of a film-forming material for forming a functional film on an eyeglass lens substrate or a functional film formed by the use of the film-forming material. More particularly, the present invention relates to a method of evaluating the performance selected from the group consisting of a sliding sensation of the functional film and an adhesion of the functional film.

Further, the present invention relates to a method of manufacturing an eyeglass lens comprising forming a functional film on an eyeglass lens substrate by the use of a film-forming material that has been determined to be non-defective as a result of the above evaluation, and to an evaluation device employed in the above evaluation method.

### BACKGROUND OF THE INVENTION

### Discussion of the Background

Various functional films are formed on lens substrates to impart desired performance to eyeglass lenses. For example, Reference 1 (WO2008/038782) or English language family member US2010/0040801A1, which are expressly incorporated herein by reference in their entirety, proposes the formation of a vapor deposited film (water-repellent film) to impart water repellency to the surface of an eyeglass lens.

In the vapor deposited film formed on the outermost surface of an eyeglass lens, such as a water-repellent film described in Reference 1, a good sliding sensation and adhesion are required in addition to imparting a desired surface property (such as water repellency) to the eyeglass lens. A good sliding sensation is required because an eyeglass lens requires the frequent wiping away of grime such as fingerprints and skin oils that adhere to the lens. Good adhesion is required to prevent separation caused by the forces that are applied during wiping and peeling over the course of long-term use. In the present specification, the term a “good sliding sensation” means that smooth wiping with little resistance is possible when wiping with a cloth or the like. The sliding sensation is normally evaluated by actual wiping by hand, but mechanical qualitative or quantitative evaluation is desirable to conduct convenient and highly reliable evaluation.

In light of such situations, the present applicant has proposed a method of evaluating the sliding sensation based on the phase change measured while vibrating the probe of an atomic force microscope on the surface of a vapor deposited film as a replacement method for the above functional evaluation of the sliding sensation, and filed a patent application (Reference 2 (see Japanese Unexamined Patent Publication (KOKAI) No. 2008-256373), which is expressly incorporated herein by reference in its entirety).

Additionally, the crosscut method is also widely employed as a method of evaluating an adhesion of a functional film that has been formed on an eyeglass lens substrate.

### SUMMARY OF THE INVENTION

The method described in Reference 2 is a good method that permits mechanical evaluation of the sliding sensation, which has formerly been evaluated based on sensation. However, it cannot be implemented with manufacturing equipment that does not include an atomic force microscope. Accordingly, were it possible to mechanically evaluate the sliding sensation by some other means than with an atomic force microscope, a practical advantage would be afforded by increasing the variety of mechanical evaluation methods available.

On the other hand, the crosscut method, which is employed as an adhesion evaluation method, requires that the surface of a functional film be cut to form squares. Thus, it cannot be employed as a method of inspecting all finished lenses. As a result, were it possible to establish a new method for evaluating adhesion that permitted the inspection of all finished lenses, it would be possible to examine adhesion and ship finished lenses that were confirmed to have a high degree of adhesion, and thus enhance the quality and reliability of the eyeglass lenses shipped as finished lenses.

An aspect of the present invention provides for a new means for evaluating with high reliability the performance of a functional film formed on an eyeglass lens substrate.

### MEANS OF SOLVING THE PROBLEM

The present inventors conducted extensive research into achieving the above object, resulting in the discovery that the change over time in the quantity of photoelectrons generated by irradiating with an X-ray a functional film formed on an eyeglass lens substrate and also a film-forming material used to form a functional film exhibited a good correlation with the sliding sensation of the surface of the functional film formed and adhesion of the functional film. The present invention was devised on that basis.

An aspect of the present invention relates to:

a method of evaluating performance of a film-forming material for forming a functional film on an eyeglass lens substrate or a functional film formed by the use of the film-forming material, wherein

the performance to be evaluated is selected from the group consisting of a sliding sensation of a surface of the functional film and an adhesion of the functional film, and

the evaluation is conducted based on a change over time in a quantity of photoelectrons generated by irradiating with an X-ray the film-forming material or the functional film.

The change over time may be an amount of change over time in a peak intensity in an XPS spectrum.

The change over time may a change in a magnitude relation of peak intensities between peaks of different binding energies in an XPS spectrum.

The XPS spectrum may be a C1s spectrum according to an XPS method.

The peak intensity may include at least either a peak intensity of a peak appearing between binding energies of 295 to 300 eV or a peak intensity of a peak appearing between binding energies of 285 to 290 eV.

A further aspect of the present invention relates to:

a method of manufacturing an eyeglass lens comprising a functional film on an eyeglass lens substrate, which comprises forming the functional film by the use of a film-forming material that has been determined to be non-defective as a result of evaluation by the method of evaluating performance as set forth above;

an evaluation device evaluating performance of a film-forming material for forming a functional film on an eyeglass lens substrate or a functional film formed by the use of the film-forming material, which is employed to carry out the method of evaluating performance as set forth above, and comprises:

an X-ray irradiating part which irradiates the film-forming material or the functional film with an X-ray;

a measuring part which measures a change over time in a quantity of photoelectrons generated from the film-forming material or the functional film irradiated with an X-ray; and

a determining part which determines whether or not the performance selected from the group consisting of a sliding sensation of a surface of the functional film and an adhesion of the functional film is non-defective based on the change over time that has been measured.

The present invention permits evaluation of the sliding sensation and adhesion of a functional film formed, not just by evaluating the functional film, but also by evaluating the film-forming material itself. Thus, a film-forming material that is capable of forming a functional film affording a good sliding sensation and adhesion can be selected without forming a film for testing.

### BRIEF DESCRIPTION OF THE DRAWINGS

FIG. 1 shows changes over time in the XPS spectrum (C1s spectrum) of film-forming material 1, described further below.

FIG. 2 shows changes over time in the XPS spectrum (C1s spectrum) of film-forming material 2, described further below.

FIG. 3 shows changes over time in the peak intensity of peaks in the binding energy range of 295 to 300 eV in the XPS spectrum (C1s spectrum) of film-forming materials 1 to 3, described further below

FIG. 4 is a schematic of a durability testing device employed in Examples.

### DETAILED DESCRIPTION OF THE EMBODIMENTS

An aspect of the present invention relates to a method of evaluating performance of a film-forming material for forming a functional film on an eyeglass lens substrate or a functional film formed by the use of the film-forming material. The method of evaluating performance of the present invention evaluates the performance selected from the group consisting of a sliding sensation of a surface of the functional film and an adhesion of the functional film based on a change over time in a quantity of photoelectrons generated by irradiating with an X-ray the film-forming material or the functional film.

X-ray photoelectron spectrometry (XPS) is known as an analysis method based on photoelectrons generated by irradiation with an X-ray. For example, Japanese Unexamined Patent Publication (KOKAI) No. 2003-66640, which is expressly incorporated herein by reference in its entirety, proposes evaluation of the durability of the characteristics of a photosensitive material in an organic photosensitive layer from the peak intensity ratio in the XPS spectrum. However, nowhere in the conventional art, including Japanese Unexamined Patent Publication (KOKAI) No. 2003-66640, is it suggested that there is a relation between the change over time in the quantity of photoelectrons produced by irradiation with an X-ray and the sliding sensation of a functional film on an eyeglass lens substrate.

By contrast, the present inventors discovered that functional films formed of film-forming materials that undergo a considerable change over time in the quantity of photoelectrons generated by irradiation with an X-ray and functional films that undergo such a considerable change over time have a poor sliding sensation and adhesion. That is, they discovered the existence of a good correlation between the above change over time and the sliding sensation and adhesion. The present invention was devised on that basis. The method of evaluating performance of the present invention permits the evaluation of a functional film actually formed on an eyeglass lens substrate, as well as evaluation of the film-forming material prior to film formation on an eyeglass lens substrate. Thus, it is possible to select a film-forming material permitting the formation of a functional film with a good sliding sensation and adhesion without forming a film for testing.

The method of evaluating performance of the present invention is described in greater detail below.

The method of evaluating performance of the present invention is used to evaluate the performance selected from the group consisting of the sliding sensation of the surface of a functional film formed on an eyeglass lens substrate and the adhesion of the functional film. Just one from among the sliding sensation and adhesion can be evaluated, or they can both be evaluated. As set forth above, a good sliding sensation refers to the ability to permit smooth wiping with a cloth or the like with little resistance. The method of evaluating performance of the present invention permits the quantitative evaluation of the sliding sensation, previously difficult to evaluate mechanically, by means of the change over time in the quantity of photoelectrons that are generated by irradiation with an X-ray. Further, in the present invention, the term “adhesion of a functional film” means the adhesion between the functional film and the surface positioned directly beneath it. The term “surface positioned directly beneath the functional film” means the surface of the lens substrate in the case where the functional film is directly formed on the lens substrate, and means the surface of the layer adjacent to the functional film when another layer is present between the lens substrate and the functional film. The method of evaluating performance of the present invention permits the quantitative evaluation of the adhesion of the functional film by means of the change over time in the quantity of photoelectrons generated by irradiation with an X-ray, and can be used in place of the crosscut method.

The substrate of the eyeglass lens on which the functional film is formed can be made of inorganic glass or plastic. From the perspective of durability, a plastic eyeglass lens substrate is desirable. Examples of plastic lens substrates are plastic lenses such as methyl methacrylate homopolymer; copolymers of monomer components in the form of methyl methacrylate and one or more other monomers; diethylene glycol bisallyl carbonate homopolymer; copolymers of monomer components in the form of diethylene glycol bisallyl carbonate and one or more other monomers; sulfur-containing copolymers; halogen-containing copolymers; polycarbonates; polystyrenes; polyvinyl chloride; unsaturated polyester; polyethylene terephthalate; and polyurethane. The functional film being evaluated or the functional film formed of a film-forming material that is being evaluated can be directly formed on a lens substrate or indirectly formed via some other functional film. In the latter case, examples of the other functional film that is formed are antireflective films and hardcoat films. Reference can be made to paragraph [0055] of Japanese Unexamined Patent Publication (KOKAI) No. 2008-256373, for antireflective films. From the perspective of enhancing the durability of the lens, hardcoat films that contain organic silicon compounds and metal oxide particles are desirable. Examples of such hardcoat compositions that permit the formation of hardcoat layers are described in Japanese Unexamined Patent Publication (KOKAI) Showa No. 63-10640, which is expressly incorporated herein by reference in its entirety.

Examples of desirable embodiments of the above organic silicon compound is the organic silicon compound denoted by general formula (I) below or hydrolysis products thereof.

(R¹)ₐ(R³)_{b}Si(OR²)_{4-(a+b)} (I)

In general formula (I), R¹ denotes an organic group comprising a glycidoxy group, epoxy group, vinyl group, methacryloxy group, acryloxy group, mercapto group, amino group, phenyl group, or the like; R² denotes an alkyl group with 1 to 4 carbon atoms, an acyl group with 1 to 4 carbon atoms; or an aryl group with 6 to 10 carbon atoms; R³ denotes an alkyl group with 1 to 6 carbon atoms or an aryl group with 6 to 10 carbon atoms; and each of a and b denotes 0 or 1.

The alkyl group with 1 to 4 carbon atoms that is denoted by R² is a linear or branched alkyl group, specific examples of which are a methyl group, ethyl group, propyl group, and butyl group.

The acyl group with 1 to 4 carbon atoms that is denoted by R² is, for example, an acetyl group, propionyl group, oleyl group, or benzoyl group.

The aryl group with 6 to 10 carbon atoms that is denoted by R² is, for example, a phenyl group, xylyl group, or tolyl group.

The alkyl group with 1 to 6 carbon atoms that is denoted by R³ is a linear or branched alkyl group, specific examples of which are methyl, ethyl, propyl, butyl, pentyl, and hexyl groups.

The aryl group with 6 to 10 carbon atoms denoted by R³ is, for example, a phenyl group, xylyl group, or tolyl group.

Specific examples of the compound denoted by general formula (I) above are those compounds described in paragraph [0073] of Japanese Unexamined Patent Publication (KOKAI) No. 2007-077327, which is expressly incorporated herein by reference in its entirety. Since the organic silicon compound denoted by general formula (I) comprises a curable group, a hardcoat layer can be formed as a cured film by conducting curing processing following coating.

The metal oxide particles contained in the hardcoat layer can contribute to adjusting the refractive index of the hardcoat layer and increasing its hardness. Specific examples are particles of tungsten oxide (WO₃), zinc oxide (ZnO), silicon oxide (SiO₂), aluminum oxide (Al₂O₃), titanium oxide (TiO₂), zirconium oxide (ZrO₂), tin oxide (SnO₂), beryllium oxide (BeO), and antimony oxide (Sb₂O₅). The metal oxide particles can be employed singly or in combinations of two or more. From the perspective of achieving both resistant to scratching and optical characteristics, the particle diameter of the metal oxide particles desirably falls within a range of 5 to 30 nm. For the same reasons, the content of metal oxide particles in the hardcoat layer can be suitably set taking into account the refractive index and hardness. Normally, it is about 5 to 80 mass percent of the solid component of the hardcoat composition. The metal oxide particles are desirably colloidal particles from the perspective of their dispersibility in the hardcoat layer.

The organic hardcoat layer can be formed by mixing the above components and, as needed, optional components such as organic solvents and surfactants (leveling agents) to prepare a hardcoat composition; coating the hardcoat composition over a resin layer, and conducting curing processing (thermosetting, photocuring, or the like) depending on the type of the curable group. A commonly employed coating method such as dipping, spin coating, or spraying can be used as the means of coating the hardcoat composition. Dipping or spin coating is desirable from the perspective of surface precision.

The thickness of the other functional film formed between the lens substrate and the functional film is not specifically limited and can be suitably set within a range that permits both the desired function and optical characteristics. As an example, the thickness of the hardcoat layer desirably falls within a range of 0.5 to 10 μm.

A functional film in the form of a water-repellent film or a lubricating film is desirably formed on the outermost layer of an eyeglass lens as the functional film that is to be evaluated or as a functional film formed of the film-forming material that is to be evaluated. When the functional film that is positioned as the outermost layer affords a good sliding sensation, the wearer will be able to smoothly wipe the eyeglass lens with a cloth or the like with little resistance. Additionally, good adhesion of the functional film that is positioned as the outermost layer is desirable in that the functional film does not peel off when the eyeglass lens is wiped with a cloth or the like by the wearer or in that the functional film does not separate with extended use of the eyeglass lens. An example of a functional film is one with a refractive index of 1.30 to 1.47 (desirably 1.40 to 1.45) and a film thickness of 1 to 20 nm (desirably 3 to 15 nm). A film thickness of equal to or greater than 1 nm (preferably equal to or greater than 3 nm) is desirable in that adequate durability and abrasion resistance can be achieved, and a film thickness of equal to or lower than 20 nm (preferably equal to or lower than 15 nm) is desirable in that there is no risk of transmittance being compromised by fogging or the like.

Examples of the film-forming material of the above functional film formed on the outermost surface are organic compounds, specifically fluorine-based organic compounds. In the present invention, “fluorine-based” means containing fluorine.

Fluorine-substituted alkyl group-containing organic silicon compounds are desirable as the above fluorine-based organic compound. The method of forming the functional film formed of the film-forming material is not specifically limited. For example, it can be formed by vapor deposition of the film-forming material as a vapor-deposited film.

The fluorine-substituted alkyl group-containing organic silicon compound denoted by general formula (I) below is desirable as the above fluorine-substituted alkyl group-containing organic silicon compound because it is capable of imparting a good water-repelling property or lubricating property to the outermost surface of an eyeglass lens.

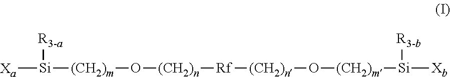

In general formula (I), Rf denotes a divalent group having a linear perfluoropolyalkylene ether structure, the linear perfluoropolyalkylene ether structure having no branched structure but including a unit denoted by formula: —(CₖF₂ₖO)— (wherein k denotes an integer of 1 to 6, desirably falling within a range of 1 to 4, and the disposition of (CₖF₂ₖO) within the formula is desirably random). When both n and n′ denote 0 in general formula (I), the end of the Rf group bonded to the oxygen atom (O) in general formula (I) is desirably not an oxygen atom. Examples of such an Rf group are given by the following general formulas. However, the present invention is not limited to the examples given below:

—CF₂CR₂O(CF₂CF₂CF₂O)₁CF₂CF₂—

(wherein 1 denotes an integer of equal to or greater than 1, desirably 1 to 50, and preferably, falling within a range of 10 to 40;

—CF₂(OC₂F₄)ₚ—(OCF₂)_{q}—

(wherein each of p and q denotes an integer of equal to or greater than 1, desirably 1 to 50, and preferably, falling within a range of 10 to 40, with the sum of p+q being an integer of 10 to 100, desirably 20 to 90, and preferably, falling within a range of 40 to 80, and the disposition of the repeating units (OC₂F₄) and (OCF₂) in the above formula being random).

In general formula (I), X denotes a hydrolyzable group or a halogen atom. Examples of the hydrolyzable group denoted by X are: alkoxy groups such as methoxy, ethoxy, propoxy, and butoxy groups; alkoxyalkoxy groups such as methoxymethoxy, methoxyethoxy, and ethoxyethoxy groups; a alkenyloxy groups such as allyloxy and isopropenoxy groups; acyloxy groups such as acetoxy, propionyloxy, butylcarbonyloxy, and benzoyloxy groups; ketooxime groups such as dimethylketooxime, methyl ethyl ketooxime, diethyl ketooxime, cyclopentanoxime, and cyclohexanoxime groups; amino groups such as N-methylamino, N-ethylamino, N-propylamino, N-butylamino, N,N-dimethylamino, N,N-diethylamino, and N-cyclohexylamino groups; amido groups such as N-methylacetamide, N-ethylacetamide, and N-methylbenzamide groups; and aminoxy groups such as N,N-dimethylaminoxy and N,N-diethylaminoxy groups.

Examples of the halogen atom denoted by X are chlorine, bromine, and iodine atoms.

Of these, a methoxy group, ethoxy group, isopropenoxy group, and chlorine atom are desirable.

In general formula (I), R denotes a monovalent hydrocarbon group with 1 to 8 carbon atoms. When multiple instances of R are present, they may be identical or different from each other. Specific examples of hydrocarbon groups denoted by R are: alkyl groups such as methyl, ethyl, propyl, butyl, pentyl, hexyl, heptyl, and octyl groups; cycloalkyl groups such as cyclopentyl and cyclohexyl groups; aryl groups such as phenyl, tolyl, and xylyl groups; aralkyl groups such as benzyl and phenethyl groups; and alkenyl groups such as vinyl, allyl, butenyl, pentenyl, and hexenyl groups. Of these, monovalent hydrocarbon groups with 1 to 3 carbon atoms are desirable, and a methyl group is preferred.

In general formula (I), each of n and n′ independently denotes an integer falling within a range of 0 to 2, and desirably denotes 1. n and n′ may be identical or different from each other. Each of m and m′ independently denotes an integer of 1 to 5, desirably 3. m and m′ may be identical or different from each other.

In general formula (I), each of a and b independently denotes 2 or 3, and desirably denotes 3 from the perspectives of hydrolysis and condensation reaction properties and coating adhesion.

The molecular weight of the fluorine-substituted alkyl group-containing organic silicon compound (perfluoropolyalkylene ether-modified silane) denoted by general formula (I) is not specifically limited, and from the perspectives of stability and ease of handling, a number average molecular weight of 500 to 20,000 is suitable and 1,000 to 10,000 is desirable.

Specific examples of the perfluoropolyalkylene ether-modified silane denoted by general formula (I) are the compounds denoted by the following structural formulas. However, the present invention is not limited to the examples given below.

(CH₃O)₃SiCH₂CH₂CH₂OCH₂CF₂CF₂O(CF₂CF₂CF₂O)₁CF₂CF₂CH₂OCH₂CH₂CH₂Si(OCH₃)₃

(CH₃O)₂CH₃SiCH₂CH₂CH₂OCH₂CF₂CF₂O(CF₂CF₂CF₂O)₁CF₂CF₂CH₂OCH₂CH₂CH₂SiCH₃(OCH₃)₂

(CH₃O)₃SiCH₂CH₂CH₂OCH₂CF₂(OC₂F₄)ₚ(OCF₂)_{q}OCF₂CH₂OCH₂CH₂CH₂Si(OCH₃)₃(CH₃O)₂CH₃SiCH₂CH₂CH₂OCH₂CF₂(OC₂F₄)ₚ(OCF₂)_{q}OCF₂CH₂OCH₂CH₂CH₂SiCH₃(OCH₃)₂

(CH₃O)₃SiCH₂CH₂CH₂OCH₂CH₂CF₂(OC₂F₄)ₚ(OCF₂)_{q}OCF₂CH₂CH₂OCH₂CH₂CH₂Si(OCH₃)₃

(C₂H₅O)₃SiCH₂CH₂CH₂OCH₂CF₂(OC₂F₄)ₚ(OCF₂)_{q}OCF₂CH₂OCH₂CH₂CH₂Si(OC₂H₅)₃

The compound denoted by general formula (I) can be used singly or in combinations of two or more. Further, the perfluoropolyalkylene ether-modified silane can be employed in combination with a partially hydrolyzed condensation product thereof.

The perfluoropolyalkylene ether-modified silane denoted by general formula (I) is desirably diluted with a solvent for use. Examples of solvents that can be employed are fluorine-modified aliphatic hydrocarbon-based solvents (such as perfluoroheptanes and perfluorooctanes), fluorine-modified aromatic hydrocarbon-based solvents (such as 1,3-di(trifluoromethyl)benzene and trifluoromethylbenzene), fluorine-modified ether-based solvents (such as methyl perfluorobutyl ether and perfluoro(2-butyltetrahydrofuran)), fluorine-modified alkylamine-based solvents (such as perfluorotributylamine and perfluorotripentylamine), hydrocarbon-based solvents (petroleum benzin, mineral spirits, toluene, and xylene), and ketone-based solvents (such as acetone, methyl ethyl ketone, and methyl isobutyl ketone). These may be employed singly or in combinations of two or more. Of these, from the perspectives of modified silane solubility, wettability, and the like, the fluorine-modified solvents are desirable, and 1,3-di(trifluoromethyl)benzene, perfluoro(2-butyletrahydrofuran), and perfluorotributylamine are preferred.

The fluorine-based organic compound, including the compound denoted by general formula (I) above, is desirably employed in combination with a modified silicone oil to enhance the sliding sensation by imparting the lubricating property. As needed, the durability and abrasion resistance of the coating film obtained can be increased by employing such a modified silicone oil in combination with a coupling agent. This is attributed to the formation of a substance having a complex three-dimensional structure by employing the modified silicone oil with a coupling agent. The silicone oil denoted by general formula (II) below is desirable as such a modified silicone oil, and the silane compound denoted by general formula (II) below is desirable as a coupling agent. Mixing the compound denoted by general formula (I) with the compound denoted by general formula (II) and the compound denoted by general formula (III) to obtain a vapor deposition material can yield a vapor deposition film of good durability and abrasion resistance. This is thought to occur due to bonding of the modified silicone oil denoted by general formula (III) induced by the silane coupling agent in the form of the silane compound denoted by general formula (II), resulting in a compound having a complex three-dimensional structure, such that in a vapor deposited state, the fluorine-substituted alkyl group-containing organic silicon compound denoted by general formula (I) is protected by the reaction product of the silane compound of general formula (II) and the modified silicone oil denoted by general formula (III).

R′—Si(OR″)₃

and/or

Si(OR″)₄ General formula (II)

In general formula (II), R denotes an organic group such as an alkyl group (methyl group, ethyl group, propyl group, or the like) having 1 to 50 (desirably 1 to 10) carbon atoms, epoxyethyl group, glycidyl group, or amino group; these may be optionally substituted.

In general formula (II), R″ denotes an alkyl group, desirably an alkyl group (methyl group, ethyl group, propyl group, or the like) with 1 to 48 carbon atoms, preferably a methyl group or an ethyl group.

The following compounds are specific examples of the silane compound denoted by general formula (II). However, the present invention is not limited to the specific examples given below.

(C2H₅O)₃SiC₃H₆NH₂,(CH₃O)₃SiC₃H₆NH₂,(C₂H₅O)₄Si,(C₂H₅O)₃Si—O—Si(OC₂H₅)₃.

The silane compound denoted by general formula (II) may be employed singly or in combinations of two or more. As the compound denoted by general formula (II), R′—Si(OR″)₃ may be employed singly, or more than Si(OR″)₄ may be employed. In that case, the three-dimensional structure of the reaction product with the modified silicone oil becomes more complex, enhancing durability and abrasion resistance.

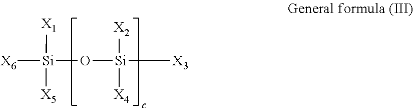

In general formula (III), c denotes an integer of equal to or greater than 1, desirably from 1 to 60, and preferably, from 1 to 10.

In general formula (III), each of X₁ to X₆ independently denotes an organic group. Specific examples thereof are alkyl groups (such as methyl, ethyl, and propyl groups) having 1 to 20 carbon atoms, epoxyethyl groups, glycidyl groups, amino groups, and carboxyl groups; these may be optionally substituted. In general formula (III), X₁ and X₅, and/or X₂ and X₄, comprise methyl groups.

The compound denoted by general formula (III) may be employed singly or in combinations of two or more.

Specific examples of the modified silicone oil denoted by general formula (III) are the compounds denoted by the following structural formulas. However, the present invention is not limited to the examples given below.

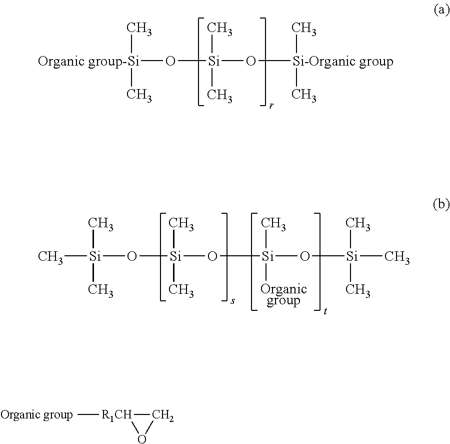

[In the organic groups given by (a) and (b), R₁ denotes an alkylene group (such as a methylene group, ethylene group, or propylene group), r denotes an integer ranging from 1 to 20, s denotes an integer ranging from 1 to 20, and t denotes an integer ranging from 1 to 40.]

Reference can be made to paragraphs [0025] to [0033] of WO2008/038782, and paragraphs [0042] to [0052] of Japanese Unexamined Patent Publication (KOKAI) No. 2008-256373, for methods of forming various vapor deposited films, including vapor deposited films containing the above components. However, the film that is the target of evaluation by the present invention is not limited to vapor deposited films. The evaluation method of the present invention can be used on films formed by spin coating, dipping, and the like.

The fluorine-based organic compound denoted by general formula (1) below, the fluorine-based nitrogen-containing organic compound denoted by general formula (2) below, and the fluorine-based nitrogen-containing organic compound denoted by general formula (3) below are examples of suitable film-forming materials (lubricants) for forming a lubricating film by the spin coating or dipping method.

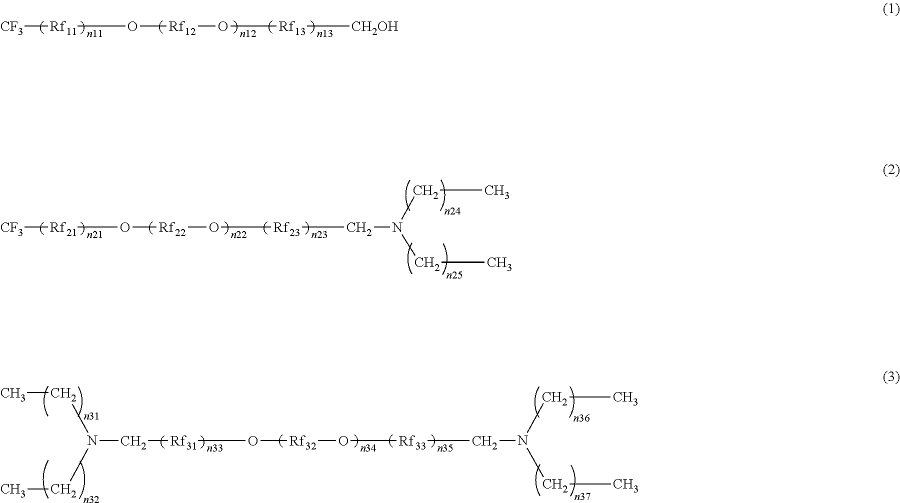

In general formulas (1) to (3), each of Rf₁₁, Rf₁₂, Rf₁₃, Rf₂₁, Rf₂₂, Rf₂₃, Rf₃₁, Rf₃₂, and Rf₃₃ independently denotes a group represented by —(CF₂)m-; m denotes an integer falling within a range of 1 to 6; and each of n₁₁, n₁₂, n₁₃, n₂₁, n₂₂, n₂₃, n₂₄, n₂₅, n₃₁, n₃₂, n₃₃, n₃₄, n₃₅, n₃₆, and n₃₇ independently denotes an integer falling within a range of 1 to 5. Specific examples of the film-forming materials denoted by general formulas (1) to (3) above are the fluorine-based organic compounds and fluorine-based nitrogen-containing organic compounds given below. Below, m denotes an integer falling within a range of 1 to 5.

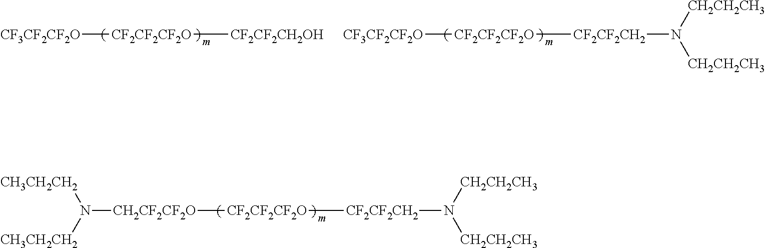

The compounds denoted by general formulas (1) to (3) can be synthesized by known methods and are readily available as commercial products. They can be employed singly or in combinations of two or more as film-forming materials to form lubricating films. They can also be mixed with solvents and known additives for use as film-forming materials.

The method of evaluating the sliding sensation and adhesion in the present invention will be described next.

In the present invention, the performance selected from the group consisting of the sliding sensation and the adhesion of a functional film formed on an eyeglass lens substrate is evaluated based on the change over time in the quantity of photoelectrons generated by irradiating with an X-ray a film-forming material for forming the functional film or a functional film formed on an eyeglass lens substrate. Here, for example, the functional film that is the target of evaluation can be the finished product itself, or a functional film on an eyeglass lens that has been formed for use in evaluation, such as a lens manufactured in the same lot as the finished product. The film-forming material that is the target of evaluation can be the composition that is used to form the functional film itself, just a component exhibiting a desired function (such as the above-mentioned fluorine-based organic compound), or a mixture obtained by mixing that component with one or more other components. In addition, the film-forming material that is the target of evaluation can be in the form of film formed by any film-forming method, or in a sealed state in a sample tube. The fact that the evaluation can be conducted in any state is advantageous from the perspective of permitting evaluation of the performance based on evaluation of the film-forming material itself without having to form a film for testing.

The evaluation apparatus used to induce the generation of photoelectrons by irradiation with an X-ray is not specifically limited other than that it be an apparatus capable of irradiating an evaluation sample with an X-ray, desirably a soft X-ray, and measuring the quantity of photoelectrons generated by the sample when irradiated with the X-ray. An X-ray photoelectron spectrometer (XPS; X-ray photoelectron Spectrometry) can be employed as such a device. The irradiation with an X-ray can be conducted continuously or intermittently. The irradiation period can be set based on the desired sliding sensation. Although it depends on the type of film-forming material, in Examples given further below, for film-forming materials with poor sliding sensations and adhesion, a marked change in the quantity of photoelectrons is confirmed by continuous X-ray irradiation for about 15 minutes, for example. In addition, the illumination intensity of the X-ray can be set to the value capable of generating photoelectron.

The change over time in the quantity of photoelectrons can be obtained as the amount of change over time in the total quantity (total area of the XPS spectrum) of photoelectrons detected, or as the amount of change over time in the peak intensity of a specific peak in the XPS spectrum. It is also possible to obtain the change over time in the quantity of photoelectrons as the change over time in the peak area of a specific peak. To facilitate evaluation, it is desirable to conduct evaluation based on the peak intensity.

It is further possible to obtain the change over time in the quantity of photoelectrons from the change in shape of the spectrum based on irradiation with the X-ray. For example, when two or more peaks appear at different binding energies in the XPS spectrum of a film-forming material or functional film being evaluated, whether or not the magnitude relation between peak intensities of peaks at different binding energies is changed (maintained or reversed) by irradiation with the X-ray can be used as a criterion for determining the performance selected from the group consisting of the sliding sensation and adhesion with those that maintain the magnitude relation being determined to afford a good performance selected from the group consisting of the sliding sensation and adhesion. The performance selected from the group consisting of the sliding sensation and adhesion can also be evaluated based on whether or not irradiation with the X-ray results in a change in the spectral shape, such as the disappearance of a peak or the appearance of a new peak, in the XPS spectrum.

The XPS spectrum employed in evaluation can be determined based on the film-forming material being evaluated. For example, the C1s (carbon) spectrum, which shows the bond state of carbon, is desirably employed to evaluate organic film-forming materials. An example of a peak to be watched is at least one peak appearing between the binding energies of 285 to 290 eV and between the binding energies of 295 to 300 eV, as indicated in Examples further below. However, this is not a limitation. The present inventors have surmised that the fact that film-forming materials that underwent large changes over time in the quantity of photoelectrons, that is, those that tended to readily undergo changes in structure such as the severing of bonds when irradiated with the X-ray, were unable to develop an adequate sliding sensation and adhesion on a lens substrate was the reason why a good correlation between the change in the quantity of photoelectrons over time and the sliding sensation was established.

The criterion (threshold) for determining whether or not a good sliding sensation is present can be set based on preliminary testing that may be conducted. As an example, if the quantity of change over a prescribed period (for example, 15 minutes to one hour) is within ±20 percent, the sliding sensation can be determined to be good. Alternatively, the sliding sensation can be determined to be good when the quantity of change over time is within ±5 percent when a particularly good sliding sensation is required.

The criterion (threshold) for determining whether or not good adhesion is present can also be set based on preliminary testing that may be conducted. As an example, if the quantity of change over a prescribed period (for example, 15 minutes to one hour) is within ±20 percent, the adhesion can be determined to be good. Alternatively, the adhesion can be determined to be good when the change over time is within ±5 percent when particularly good adhesion is required.

In addition, when conducting evaluation based on change in the shape of the XPS spectrum as set forth above, the sliding sensation and adhesion can be determined to be good when no change in the spectral shape (such as a reversal in the magnitude relation of the intensity of peaks) occurs within a prescribed period (for example, 15 minutes to one hour).

The above determination can be automated in a program.

Accordingly, the present invention provides:

an evaluation device evaluating performance of a film-forming material for forming a functional film on an eyeglass lens substrate or a functional film formed by the use of the film-forming material, which is employed to carry out the method of evaluating performance of the present invention, and comprises:

an X-ray irradiating part which irradiates the film-forming material or the functional film with an X-ray;

a measuring part which measures a change over time in a quantity of photoelectrons generated from the film-forming material or the functional film irradiated with an X-ray; and

a determining part which determines whether or not the performance selected from the group consisting of a sliding sensation of a surface of the functional film and an adhesion of the functional film is non-defective based on the change over time that has been measured.

The present invention further relates to a method of manufacturing an eyeglass lens comprising a functional film on an eyeglass lens substrate, which comprises forming the functional film by the use of a film-forming material that has been determined to be non-defective as a result of evaluation by the method of evaluating performance of the present invention.

The method of evaluating performance of the present invention permits the selection of film-forming materials capable of achieving a good sliding sensation and adhesion. Thus, by the use of the selected film-forming material (non-defective product) to form a functional film, it becomes possible to obtain an eyeglass lens affording a good sliding sensation and an eyeglass lens having a functional film with good adhesion.

As set forth above, the method of forming the functional film is not specifically limited; a known film-forming method such as vapor deposition, spin coating, or dipping can be employed. For example, since about 100 pieces of substrate can be simultaneously subjected to vapor deposition processing in a vapor deposition device, vapor deposition is advantageous from the perspective of large quantity production. Additional details about the manufacturing method of the present invention are as set forth above.

The present invention can further provide a method of manufacturing an eyeglass lens comprising steps of:

forming a functional film on a plurality of eyeglass lens substrates to manufacture a plurality of eyeglass lenses comprising functional films (referred to as “step I”, hereinafter);

evaluating by the method of evaluating performance of the present invention the functional film of at least one of the plurality of eyeglass lenses that have been manufactured (referred to as “step II”, hereinafter); and

determining which eyeglass lenses to ship as finished product based on results of the evaluation (referred to as “step III”, hereinafter).

As set forth above, the method of forming the functional film in step I is not specifically limited. The film can be formed by a known film-forming method, such as vapor deposition, spin coating, and dipping. Of these, from the perspective of large-quantity production, vapor deposition is desirable. For example, in the above manufacturing method, at least one of a plurality of eyeglass lenses in a single lot, such as a plurality of eyeglass lenses simultaneously subjected to vapor deposition processing in a single device is subjected to step II. Only one of the eyeglass lenses need be subjected to step II. To provide a high-quality finished product with reliability, two or more eyeglass lenses are desirably subjected to step II.

In step II, evaluation is conducted by the method of evaluating performance of the present invention on an eyeglass lens selected as a sample for evaluation in step I. The details are as set forth above.

In step III, based on the evaluation results obtained in step II, the eyeglass lenses to be shipped as finished product are determined. This determination of eyeglass lenses to be shipped can be conducted by the following methods, for example.

(1) When the results of the evaluation of the sample evaluated in step II satisfy the non-defective determination criterion, the eyeglass lenses in the same lot as the sample are determined to satisfy the non-defective determination criterion, and the eyeglass lenses in the same lot are shipped as finished product.
(2) Each eyeglass lens manufactured is subjected to step II, and when the evaluation results in step II satisfy the non-defective determination criterion, the eyeglass lens is shipped as a finished product. By evaluating all of the finished product prior to shipment, it becomes possible to provide a finished product with higher reliability. As set forth above, in adhesion evaluation by the crosscut method, it is difficult to evaluate every eyeglass lens. By contrast, in the present invention, the adhesion of each and every eyeglass lens can be evaluated.

The functional film formed on eyeglass lenses that are determined to be defective by the method of evaluating performance of the present invention can be removed and a new functional film can be formed, or another functional film can be formed over the defective functional film. Thus, the number of eyeglass lenses that are discarded as defective product can be reduced, which is advantageous from the perspectives of cost and consideration of the environment.

### EXAMPLES

The present invention will be described in detail below based on Examples. However, the present invention is not limited to the embodiments shown in Examples.

### 1. Evaluation of Fluorine-Based Organic Compounds

### (1) Samples to be Evaluated

The following three fluorine-based organic compounds were employed as film-forming materials to be evaluated:

Film-forming material 1: A fluorine-based organic compound having a main skeleton in the form of the repeat of the following unit structure

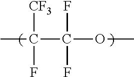

Film-forming material 2: A fluorine-based organic compound having a block copolymer of the following two structural units as a main skeleton

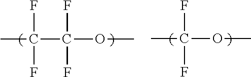

Film-forming material 3: A fluorine-based organic compound having the same main skeleton as film-forming material 2

### (2) Evaluation by XPS

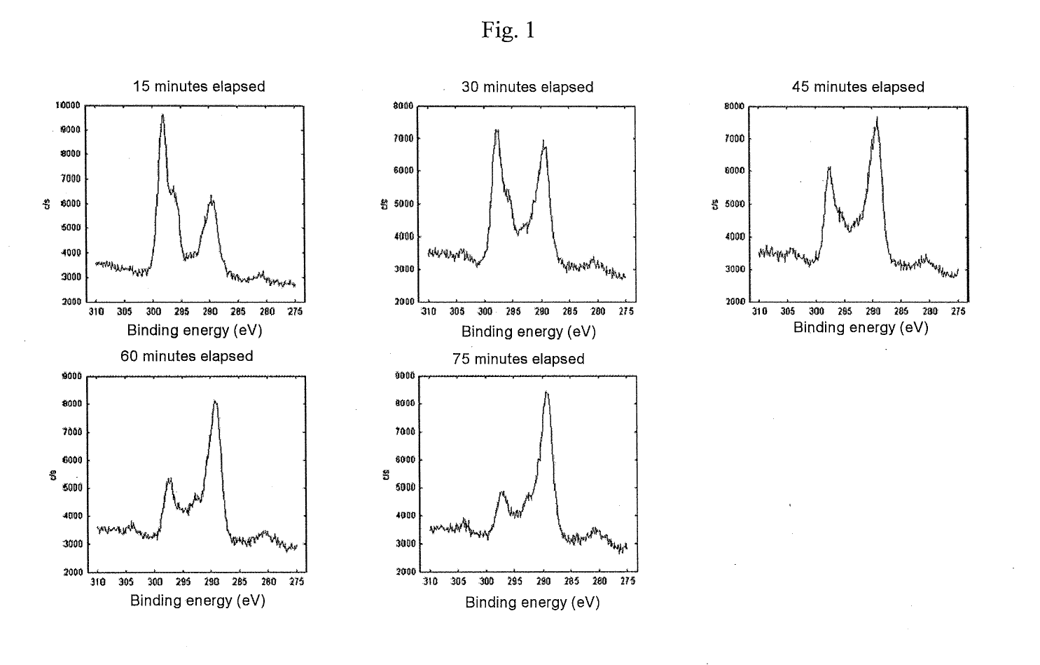

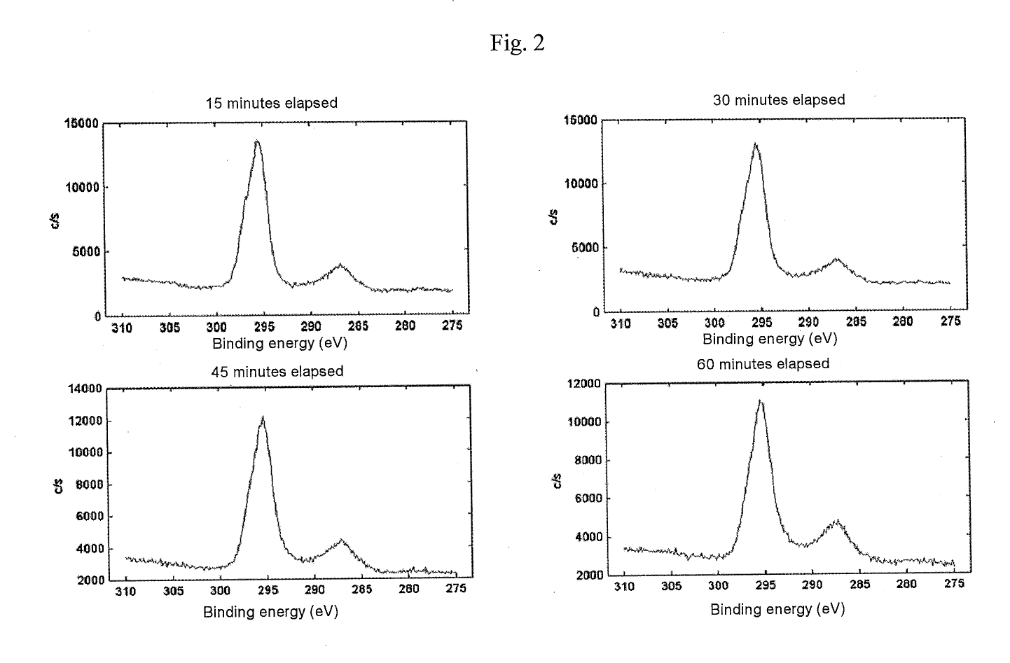

A 5 to 20 g quantity of each of the above film-forming materials was sealed in a test tube. Film-forming compound I was continuously irradiated with an X-ray for 75 minutes, film-forming materials 2 and 3 were continuously irradiated with an X-ray for 60 minutes in an XPS analyzer, and the change over time in the C1s spectrum (narrow spectrum) was observed. An ESCA5400MC made by Physical Electronics was employed as the XPS analyzer. FIG. 1 shows the change over time in the C1s spectrum obtained for film-forming material 1 and FIG. 2 shows the change over time in the C1s spectrum obtained for film-forming material 2. The change over time in the C1s spectrum of film-forming material 3 was nearly identical to that of film-forming material 2.

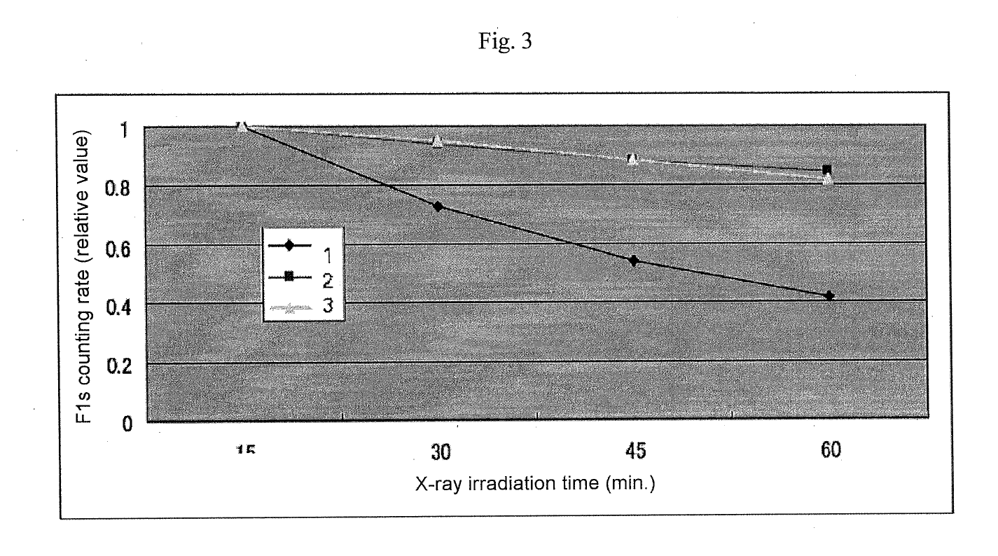

As shown in FIG. 1, in the C1s spectrum of film-forming material 1, peaks appeared in the binding energy regions of 285 to 290 eV and 295 to 300 eV. In both peaks, the peak intensity increased or decreased (the quantity of photoelectrons generated changed) and the spectral shape changed over time. By contrast, as shown in FIG. 2, peaks were confirmed at the same positions in film-forming material 2, but no change in peak intensity of a degree indicating a change in the spectral shape was found in the evaluation. Accordingly, FIG. 3 shows a graph of the change over time during the period from 15 minutes to 60 minutes following the start of irradiation with X-rays of the peak top intensity (for film-forming material 1, a peak intensity at a binding energy of about 298 eV, for film-forming materials 2 and 3, peak intensities at a binding energy of about 296 eV) between the binding energies of 295 to 300 eV in which a marked drop in peak intensity was seen over time in film-forming materials 1 to 3. As shown in FIG. 3, film-forming material 1 exhibited a drop of 60 percent in peak intensity in 45 minutes. Film-forming materials 2 and 3 exhibited a reduction of equal to or less than 20 percent in peak intensity in 45 minutes.

### 2. Preparation of Vapor Deposition Material (Water-Repellent Treatment Agent)

A vapor deposition material (water-repellent agent) was prepared by the following method. A 30 cc glass screw bottle made by AS ONE Corporation was employed as the container, and the stirrer was set to a speed of 500 rpm.

TABLE 1

| Step | Starting material name | Quantity employed | Mixing time |
|---|---|---|---|
| 1 | KBE903 + KF105 | 10 g + 10 g | 24 hours |
| 2 | Water-repellent agent + | 15 g + 3.5 g | 24 hours |
| | product of step 1 | | |
| 3 | Product of step 2 + | 18.5 g + 3 g | 24 hours |
| | HFE7200 | | |

### (Step 1) Preparing a Reaction Solution of a Silane Compound and Silicone Oil

A silane compound of general formula (II) in the form of 10 g of KBE903 ((C₂H₅O)₃SiC₃H₆NH₂, molecular weight 221.4, refractive index (25° C.) 1.420), made by Shin-Etsu Chemical Co., Ltd. and a modified silicone oil of general formula (III) in the form of 10 g of KF105 (kinematic viscosity 15 mm²/s (25° C.), refractive index (25° C.) 1.442, functional group equivalent amount 490 g/mol) made by Shin-Etsu Chemical Co., Ltd. having the structure of the oil (a) below were mixed for 24 hours.

The above silane compound had an amino group and the above silicone oil had an epoxyethyl group. Thus, the amino group reacted with the glycidyl group, producing a mixture containing dimethylsiloxane having secondary and tertiary amines. This reaction took about 24 hours. The production of compounds with molecular weights of about 200 to 1,000 was confirmed by H and C NMR analysis.

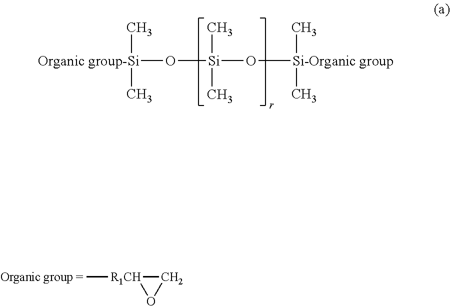

[In the above organic group, R¹ is an alkylene group (methylene, ethylene, propylene groups and the like), r is an integer ranging from 1 to 20, s is an integer ranging from 1 to 20, and t is an integer ranging from 1 to 40.]
(Step 2) Mixing a Fluorine-Based Organic Compound (Water-Repellent Agent) with the Reaction Solution of the Silane Compound and Silicone Oil Compound

Next, 3.5 g of the solution produced in step 1 was added to 15 g of each of film-forming materials 1 to 3 and mixtures were stirred for 24 hours.

### (Step 3) Process of Mixing Hydrofluoroether to Enhance the Pouring Property and Drying Property

To 18.5 g of the mixed solution prepared in step 2 was added 3 g of hydrofluoroether in the form of HFE7200 (C₄F₉OC₂H₅, viscosity 5.7×10⁻⁴ Pa·s, kinematic viscosity 0.40 mm²/s, refractive index (25° C.) 1.28) made by Sumitomo 3M and the mixture was stirred for 24 hours.

A vapor deposition material (water-repellent treatment agent) was obtained by the above steps.

### 3. Forming a Hardcoat Film

To a glass container equipped with magnetic stirrer were charged 17 mass parts of γ-glycidoxypropyltrimethoxysilane, 30 mass parts of methanol, and 28 mass parts of an aqueous dispersion of colloidal silica (solid component 40 mass percent, average particle diameter 15 nm). The mixture was thoroughly mixed and then stirred for 24 hours at 5° C. Next, 15 mass parts of propylene glycol monomethyl ether, 0.05 mass part of silicone-based surfactant, and 1.5 mass parts of curing agent in the form of aluminum acetylacetonate were added. The mixture was then thoroughly stirred and filtered to prepare a hardcoating liquid (hardcoat composition). This coating liquid had a pH of about 5.5.

Meniscus-shaped polythiourethane (made by HOYA Corporation, product name EYAS, center thickness 2.0 mm, diameter 75 mm, convex surface curvature (average value) about +0.8) was employed as a plastic eyeglass lens substrate. The hardcoating liquid that had been prepared was coated by dipping (upward drawing speed 20 cm/minute) to the convex surface of the lens substrate. Thermosetting was conducted for 60 minutes at 100° C. to form a hardcoat film 3 μm in thickness.

### 4. Forming a Water-Repellent Film

Stainless steel sintered filters (pore diameter 80 to 100 μm, diameter 18 mm, thickness 3 mm) impregnated with 0.35 mL of each of the water-repellent treatment agents obtained in 2. above were heated for 2 hours in a dry oven at 80° C. and then placed in a vacuum vapor deposition apparatus. An electron gun (EB) was employed under the conditions indicated below to heat the entire sintered filter, forming a water-repellent film about 3 nm in thickness over the hardcoat film formed in 3. above. The luminous reflectance of the lens was 0.4 percent.

### (1) Degree of Vacuum

3.1×10⁻⁴ to 8.0×10⁻⁴ Pa (2.3×10^{-6×6.0×10}⁻⁶ Torr)

### (2) Electron Gun Conditions

Acceleration voltage: 6 kV; applied voltage: 11 mA; irradiated area: 3.5×3.5 cm²; irradiation time: 120 s.

### 5. Functional Evaluation

The sensation when the outermost surface (surface of the water-repellent film) of each of the eyeglass lenses formed with film-forming materials 1 to 3 were rubbed with lens-cleaning paper was evaluated in the four stages indicated below.

◯: Good sliding sensation
X: No sliding sensation

TABLE 2

| | Sliding sensation |
|---|---|
| Lens employing film-forming material 1 | X |
| Lens employing film-forming material 2 | ◯ |
| Lens employing film-forming material 3 | ◯ |

### 6. Adhesion Evaluation by the Crosscut Method

Crosscuts forming one hundred squares were made at 1.5 mm intervals on the surface of the water-repellent film on each of the eyeglass lenses formed with film-forming materials 1 to 3. Adhesive tape (cellophane tape, made by Nichiban Co., Ltd.) was strongly adhered to the crosscut area and then quickly removed. The number of squares that peeled off among the 100 squares was then counted. The adhesion was denoted as “◯” when 1 to 2/100 squares peeled off, “Δ” when 3 to 50/100 squares peeled off, and “X” when more than 50/100 squares peeled off.

TABLE 3

| | Adhesion of |
|---|---|
| | the water- |
| | repellent film |
| Lens employing film-forming material 1 | X |
| Lens employing film-forming material 2 | ◯ |
| Lens employing film-forming material 3 | ◯ |

### 7. Other Evaluation

The above three lenses were evaluated as follows.

### (1) Static Contact Angle for Water

The above three lenses were evaluated as follows.

A contact angle meter (model CA-D, product of Kyowa Interface Science Co., Ltd.) was employed. A water droplet 2 mm in diameter was formed on the tip of the needle at 25° C. and brought into contact with the topmost portion of the outermost surface (convex surface) of the lens to form a liquid droplet. The angle formed by the liquid droplet and surface at that time was measured as the static contact angle. Denoting the radius of the water droplet (the radius of the portion of the water droplet in contact with the lens surface) as r and the height of the water droplet as h, static contact angle θ was calculated from the following formula:

θ=2×tan⁻¹ (h/r)

The static contact angle was measured within 10 seconds after bringing the water droplet into contact with the lens to minimize measurement error due to water evaporation. All of the lenses had contact angles of about 108°. When the static contact angle of the hardcoat film surface prior to the formation of the water-repellent film was separately measured by the same method, the angle measured was about 60°. All of the water-repellent films were confirmed to function as water-repellent films.

### (2) Measurement of the Coefficient of Dynamic Friction

The average coefficient of dynamic friction at a displacement distance of 20 mm was measured three times with a type 22H continuous loading surface property tester made by Shinto Scientific Co., Ltd. for the outermost surface (surface of the water-repellent film) of the above three lenses, and the average values were calculated. All were about 0.080.

### (3) Durability Evaluation

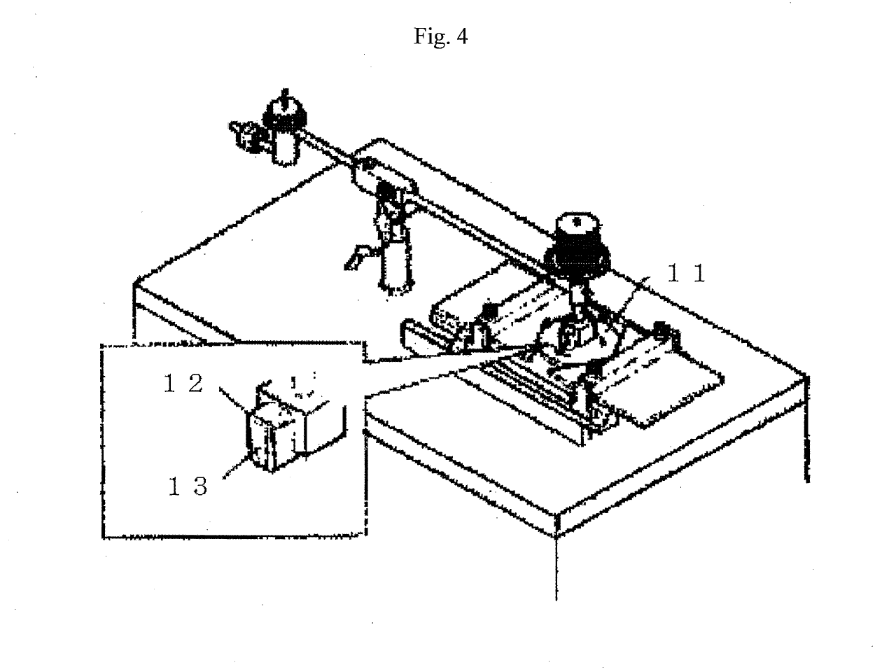

Using the device shown in FIG. 4, a 500 g load was applied with a lens-cleaning cloth (product name: HOYA Clearcloth) to the outermost surface (surface of the water-repellent film) of the above three lenses 3,600 times and rubbed back and forth (25° C., relative humidity 50 to 60 percent). Subsequently, measurement of the static contact angle for water by the method described in (1) above revealed an angle of about 106° for all of the lenses. In FIG. 4, 11 denotes a lens, 12 denotes a lens-cleaning cloth, and 13 denotes a hexahedral plate.

### (4) Appearance

The presence or absence of irregular interference coloration and changes in interference coloration were visually checked in the above three lenses. An evaluation of whether or not the appearance permitted use as an eyeglass lens resulted in the assessment that the appearance of all of the lenses was good.

### 8. Evaluation Results

As set forth above, although nearly identical results were obtained for all three lenses in the evaluation of appearance, contact angle, durability, and coefficient of dynamic friction, clear differences were present in the results of evaluation of the sliding sensation by functional evaluation, as shown in Table 2.

As indicated in Table 2, the sliding sensation was good for the lenses made with film-forming materials 2 and 3, which exhibited changes over time (45 minutes) in the peak intensity at binding energies of 295 to 300 eV in the C1s spectrum of equal to or less than 20 percent. By contrast, the lens made using a film-forming material with a change in peak intensity of 60 percent exhibited an extremely poor sliding sensation. Thus, a good correlation was determined to exist between the amount of change over time in the quantity of photoelectrons generated by irradiation with X-rays and the sliding sensation.

In addition, as shown in FIG. 3, adhesion of the water-repellent film as evaluated by the crosscut method was good for the lenses made with film-forming materials 2 and 3, which exhibited change over time (45 minutes) in the peak intensity at binding energies of 295 to 300 eV in the C1s spectrum of equal to or less than 20 percent. By contrast, the lens made using a film-forming material with a change in peak intensity of 60 percent exhibited extremely poor adhesion of the water-repellent film as evaluated by the crosscut method. Thus, a good correlation was determined to exist between the amount of change over time in the quantity of photoelectrons generated by irradiation with X-rays and adhesion of the water-repellent film.

Determination of the change over time in the C1s spectrum of the water-repellent film by the same method as in 1(2) above for the above three types of lenses revealed the same trend as in the results for the film-forming materials. That is, for the water-repellent film formed by the use of film-forming material 1, the spectral shape changed over time. In particular, a large drop in the peak intensity in the binding energy region of 295 to 300 eV was observed. By contrast, no change in the spectral shape over time was observed for the water-repellent films formed by the use of film-forming materials 2 and 3. These results confirmed that the sliding sensation and adhesion could also be evaluated by XPS analysis of functional films following film formation.

Based on the above results, a non-defective determination criterion of “A change over time (45 minutes) in the peak intensity at binding energies from 295 to 300 eV in the C1s spectrum of equal to or less than 20 percent” was adopted; a terminal device (determining part) equipped with a program that passed samples that satisfied the above determination criterion was connected to an XPS analyzer (equipped with an X-ray irradiating part and a measuring part that measured the change over time in the amount of photoelectrons); and thus an evaluation device that determined non-defective and defective product based on information on the change over time in the quantity of photoelectrons outputted by the XPS analyzer was prepared. This evaluation device permitted the continuous automatic evaluation of film-forming materials and functional films.

In using the method of evaluating performance of the present invention in actual production, the film-forming material to be used in actual production can be selected based on evaluation results such as those set forth above. For example, based on the above evaluation results, the film-forming material to be used in actual production can be determined from among candidate materials based on an indicator that the film-forming material will form a water-repellent film with a good sliding sensation and adhesion when the rate of change over time in 45 minutes in the peak intensity at a binding energy of 295 eV in the C1s spectrum is equal to or less than 20 percent, and the film-forming material thus determined can be used to form water-repellent films to obtain eyeglass lenses having water-repellent films affording a good sliding sensation and adhesion.

Further, the magnitude relation between peak intensities of peaks at different binding energies can be made a non-defective determination criterion that maintains such a relation for a prescribed period without reversal. Specifically, when the peak intensity of the peak in the binding energy region of 285 to 290 eV in the C1s spectrum was denoted as “P1” and the peak intensity of the peak in the binding energy region of 295 to 300 eV was denoted as “P2,” film-forming material 1 initially exhibited P1>P2. However, continuous irradiation with X-rays caused the magnitude relation to reverse itself beginning at 45 minutes of irradiation, becoming P1<P2 (see FIG. 1). By contrast, there was no change in the magnitude relation of P1 and P2 before and after continuous irradiation with X-rays in film-forming material 2; P1>P2 was maintained (see FIG. 2). The same applied to film-forming material 3. Accordingly, it was possible to use the fact that the magnitude relation of P1>P2 did not change over time to determine that the film-forming material permitted the formation of a water-repellent film of good sliding sensation and adhesion. Since it permits the determination of non-defective product from spectral shape, this method is convenient and suited to use in actual production processes.

The method of evaluating performance of the present invention is useful in selecting water-repellent film-forming materials.

1. A method of evaluating performance of a film-forming material for forming a functional film on an eyeglass lens substrate or a functional film formed by the use of the film-forming material, wherein
the performance to be evaluated is selected from the group consisting of a sliding sensation of a surface of the functional film and an adhesion of the functional film, and
the evaluation is conducted based on a change over time in a quantity of photoelectrons generated by irradiating with an X-ray the film-forming material or the functional film.

2. The method of evaluating performance according to claim 1, wherein the change over time is an amount of change over time in a peak intensity in an XPS spectrum.

3. The method of evaluating performance according to claim 2, wherein the XPS spectrum is a C1s spectrum according to an XPS method.

4. The method of evaluating performance according to claim 3, wherein the peak intensity includes at least either a peak intensity of a peak appearing between binding energies of 295 to 300 eV or a peak intensity of a peak appearing between binding energies of 285 to 290 eV.

5. The method of evaluating performance according to claim 1, wherein the change over time is a change in a magnitude relation of peak intensities between peaks of different binding energies in an XPS spectrum.

6. The method of evaluating performance according to claim 5, wherein the XPS spectrum is a C1s spectrum according to an XPS method.

7. The method of evaluating performance according to claim 6, wherein the peak intensity includes at least either a peak intensity of a peak appearing between binding energies of 295 to 300 eV or a peak intensity of a peak appearing between binding energies of 285 to 290 eV.

8. A method of manufacturing an eyeglass lens comprising a functional film on an eyeglass lens substrate, which comprises forming the functional film by the use of a film-forming material that has been determined to be non-defective as a result of evaluation by the method of evaluating performance according to claim 1.

9. An evaluation device evaluating performance of a film-forming material for forming a functional film on an eyeglass lens substrate or a functional film formed by the use of the film-forming material, which is employed to carry out the method of evaluating performance according to claim 1, and comprises:
an X-ray irradiating part which irradiates the film-forming material or the functional film with an X-ray;
a measuring part which measures a change over time in a quantity of photoelectrons generated from the film-forming material or the functional film irradiated with an X-ray; and
a determining part which determines whether or not the performance selected from the group consisting of a sliding sensation of a surface of the functional film and an adhesion of the functional film is non-defective based on the change over time that has been measured.
